(19) United States
(12) Patent Application Publication
(10) Pub. No.: US 2017/0084907 A1
(43) Pub. Date: Mar. 23, 2017

(54) POWER-TYPE NICKEL COBALT LITHIUM MANGANESE OXIDE MATERIAL, AND PREPARATION METHOD THEREFOR AND USES THEREOF

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP END-OF-LIFE VEHICLES RECYCLING CO., LTD., Changsha (CN)

(72) Inventors: Yannan OU, Foshan (CN); Haijun YU, Foshan (CN); Changdong LI, Foshan (CN)

(73) Assignees: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP END-OF-LIFE VEHICLES RECYCLING CO., LTD., Changsha (CN)

(21) Appl. No.: 15/123,653

(22) PCT Filed: Mar. 6, 2015
(86) PCT No.: PCT/CN2015/073773

§ 371 Date: Sep. 5, 2016

(30) Foreign Application Priority Data
Mar. 4, 2014 (CN) 201410077087.2

(51) Int. Cl. H01M 4/1391; H01M 4/525; H01M 10/0525; H01M 4/04; H01M 4/131; D01D 5/00; D01D 10/02; D01F 9/10; H01M 4/505; C01G 53/00

(52) U.S. Cl. CPC H01M 4/1391; H01M 4/505; H01M 4/525; H01M 10/0525; C01G 53/44; H01M 4/131; D01D 5/0007; D01D 10/02; D01F 9/10; H01M 4/0483; H01M 4/0471; C01P 2006/40

(57) ABSTRACT

The present invention relates to the technical field of preparation of a nickel cobalt lithium manganese oxide positive electrode material. Disclosed are a power-type nickel cobalt lithium manganese oxide material and a preparation method therefor and uses thereof. The preparation method comprises: adding an organic acid into a mixed aqueous solution of a lithium source, a nickel source, a cobalt source and a manganese source, aging, obtaining a sol precursor, obtaining a gel fiber through electrospinning, and obtaining the power-type nickel cobalt lithium manganese oxide material after calcination. In the present invention, the nickel cobalt lithium manganese oxide material of a nano-fiber structure is prepared by using a sol-gel electrospinning method, and the nickel cobalt lithium manganese oxide material of a nano-fiber structure has a uniform structure size, thereby effectively reducing surface energy, and improving a capacity of lithium ions.

### TECHNICAL FIELD

The present invention relates to the technical field of preparing nickel cobalt lithium manganese oxide positive electrode material, in particular, to a power-type nickel cobalt lithium manganese oxide material and the preparing method thereof and the use thereof.

### BACKGROUND

As the situation of global energy and the environment pollution is becoming tense and worse, the consensus of using energy-saving and the new energy-powered automobile is developing among the people. Countries are launching corresponding policies and measures, step by step, to accelerate critical technical progress, and to facilitate the formation of a consumer market for these products. The output of battery powered automobile is increasing. The power battery is a battery used to provide power to a new energy automobile etc. The performance of power battery determines the performance and the battery life of the new energy automobile. The positive electrode material determines specific capacity and cycle life of the power battery. Nowadays, commercial positive electrode material mainly includes lithium cobalt oxide, lithium manganese oxide, nickel cobalt lithium manganese oxide, and lithium iron phosphate. Recently, since the nickel cobalt lithium manganese oxide has a large specific capacity and a long cycle life, the new energy automobile industry is getting more and more in favor of it.

However, due to the limitations of preparing method, the actual capacity of nickel cobalt lithium manganese oxide still has a significant difference from its theoretical capacity, which restrains the development of the new energy automobile. Methods for synthesizing nickel cobalt lithium manganese oxide material mainly include the solid phase method, the coprecipitation method, the lot-heat solid phase method, the complexometry method, sol-gel method etc. Though, the above existing synthesizing methods can obtain nickel cobalt lithium manganese oxide material, the size of the particle is large and it is difficult to control.

### SUMMARY

In order to overcome the above defects in the prior the actual capacity of nickel cobalt lithium manganese oxide is significantly different from its theoretical capacity, and the size of the particle is large, and it is difficult to control, the main purpose of the present invention is to provide a method for preparing power-type nickel cobalt lithium manganese oxide material. This method uses the technology of sol-gel-electrospinning to control the size of nickel cobalt lithium manganese oxide. A new method of preparation of power-type nickel cobalt lithium manganese oxide material is provided.

Another purpose of the present invention is to provide the power-type nickel cobalt lithium manganese oxide material prepared by the above method. This nickel cobalt lithium manganese oxide material has a higher capacitance than that of the existing material.

Yet another purpose of the present invention is to provide the use of the power-type nickel cobalt lithium manganese oxide material for preparing a battery.

The purposes of the present invention are reached by the following solutions.

A method for preparing power-type nickel cobalt lithium manganese oxide material is provided. The organic acid is added to a mixed aqueous solution of a lithium source, a nickel source, a cobalt source, and a manganese source. It is aged to obtain the sol precursor. After electrospinning, the gel fiber is obtained. After calcination, the power-type nickel cobalt lithium manganese oxide material is obtained.

In the mixed aqueous solution, the concentration of the nickel source is 1˜3 mol/L, the concentration of the cobalt source is 1˜3 mol/L. The concentration of the manganese source is 1˜3 mol/L. The concentration of the lithium source 1˜2 times of a total concentration of nickel source, cobalt source, and manganese source.

The amount of the organic acid is that after adding the organic acid the concentration of the organic acid in the system is 3˜5 mol/L.

The organic acid is at least one of citric acid, tartaric acid, and oxalic acid. In the present invention, the organic acid is added, which forms a soluble complex compound with metal ions, nickel, cobalt, manganese etc. by controlling a series of testing conditions. Thus, free ions in the solution are reduced, so as to form a uniform and transparent sol. By adding organic acid, a spinnable precursor which has sufficient viscosity is obtained.

Preferably, the lithium source is at least one of lithium acetate, lithium hydrate, and lithium carbonate.

The nickel source preferably is at least one of nickel acetate, nickel hydroxide, and nickel carbonate.

The cobalt source preferably is at least one of cobalt acetate, cobalt hydroxide, and cobalt carbonate.

The manganese source preferably is at least one of manganese acetate, manganese hydroxide, and manganese carbonate.

The aging refers to heating it up to 60˜70° C. Then, it is aged for 8˜10 hours till it is transparent. It continues to be aged at the room temperature till the viscosity is 2˜3 Pa·s.

Process conditions of the electrospinning include that the nozzle aperture is 500 μm, the feeding rate is 5˜10 mL/h, the voltage is 20˜40 kV, the fixed distance between the nozzle, the collector is 10˜30 cm, and the pressure is 0.3˜0.5 MPa.

Process conditions of the calcination include that the temperature is raised from the room temperature to 300˜400° C. at a rate of 0.5˜1° C./min and is held for 13 hours. Then the temperature is raised to 600˜800° C. at a rate of 2˜4° C./min and is held for 8˜10 hours.

Preferably, after electrospinning, the obtained gel fiber is dried at 70° C. for 1 hour. Then, the calcination is conducted.

The power-type nickel cobalt lithium manganese oxide material prepared by the above method has a nanofiber structure, a uniform size, and a larger specific capacity, which is suitable to be used as the electrode material in the battery.

The principle of the present invention is:

The present invention uses the sol-gel-electrospinning method to prepare the nickel cobalt lithium manganese oxide material which has a nanofiber structure. First, the organic acid is added, which forms a soluble complex compound with metal ions, nickel, cobalt, manganese etc. by controlling a series of testing conditions. Thus, free ions in the solution are reduced, so as to form a uniform and transparent sol. With the sol precursor which has sufficient viscosity, the gel fiber is sprayed under control using the electrospinning instrument to control the suitable spinning conditions. Ultimately, after programmed heating-up calcination, the crystallinity of nickel cobalt lithium manganese oxide material is improved. The nickel cobalt lithium manganese oxide material has the uniform structure and size, reducing the surface energy effectively. Therefore, the coulomb repulsion between lithium ions decreases, such that the capacity of lithium ions increases. Moreover, the nanofiber structure can cut down the impedance of the diffusion of lithium ions during intercalation and deintercalation, making lithium ions diffuse rapidly. At the same time, as compared to the micrometer-scale material prepared by traditional deposition method, the nanoscale material has a larger surface area, more reactive sites, and a higher specific capacity.

As compared to prior art, the present invention has the following advantages and benefits:

(1) The nickel cobalt lithium manganese oxide material of the present invention has uniform size and the nanofiber structure, which can effectively enhance the capacity of lithium ions.

(2) The nickel cobalt lithium manganese oxide material of the present invention has a larger surface area, more reactive sites, and a higher specific capacity.

(3) The sol-gel-electrospinning method of the present invention is simple, which is achieved without adding polymeric reagent. Not only the cost of polymeric is removed, but also the effect of polymer to the nanostructure is eliminated. This is because, on one hand, traditional electrospinning needs to add soluble polymer in the solution to improve the spinnability of the raw material. However, the present invention adds organic acid into the solution to form the sol to obtain a spinnable precursor. On the other hand, the traditional method first introduces polymer, and then removes the polymer after calcination. Since the pinned “polymeric-nickel cobalt lithium manganese oxide” has combined closely, removing the polymer will cause deficiencies on the structure of nickel cobalt lithium manganese oxide material, such that the performance of the material is affected.

### BRIEF DESCRIPTION OF THE DRAWINGS

FIG. 1 is the SEM (scanning electron microscope) picture of nickel cobalt lithium manganese oxide material prepared through Embodiment 1.

FIG. 2 is the curve graph of the capacity of charging and discharging of the nickel cobalt lithium manganese oxide material of Embodiment 1 and that of the comparing example.

### DETAILED DESCRIPTION

Hereinafter, the present invention is further described in detail in accompany with embodiments and Figures. However, embodiments of the present invention are not limited hereto.

### Embodiment 1

### The Preparation of the Power-Type Nickel Cobalt Lithium Manganese Oxide Material

(1) 100 mL of mixed aqueous solution is prepared, wherein the concentrations are lithium acetate 3 mol/L, nickel acetate 1 mol/L, cobalt acetate 1 mol/L, manganese acetate 1 mol/L. The citric acid is added into the system, such that the concentration of sodium citrate is 3 mol/L. It is aged at 60° C. for 10 hours till it is sticky and transparent. It continues to be aged at the room temperature till the viscosity is 2 Pa·s, so as to obtain the sol precursor.

(2) The sol is put into a syringe whose nozzle aperture is 500 μm. The feeding rate is 5 mL/h. The voltage is 20 kV. The fixed distance between the nozzle and the collector is 10 cm. N₂ is blown in till the pressure is 0.3 MPa. The spinning is conducted under the above conditions. Gel fibers are obtained. They are dried at 70° C. for 1 hour.

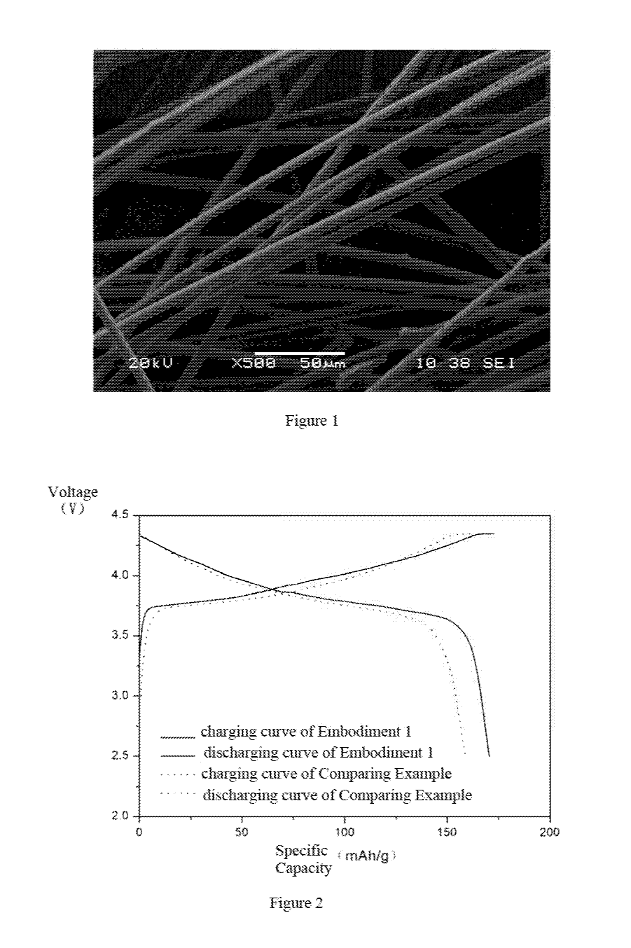

(3) Gel fibers obtained in step (2) are put into the calcinatory. In the atmosphere, the temperature is raised from the room temperature to 300° C. at a rate of 0.5° C./min and is held for 1 hour, and then is raised to 600° C. at a rate of 2° C./min and is held for 8 hours. The power-type nickel cobalt lithium manganese oxide material is obtained. The SEM is conducted, and the results are shown in FIG. 1. As shown in FIG. 1, the power-type nickel cobalt lithium manganese oxide material the present invention has uniform nanofiber structure.

### Embodiment 2

### The Preparation of the Power-Type Nickel Cobalt Lithium Manganese Oxide Material

(1) 100 mL of mixed aqueous solution is prepared, wherein the concentrations are lithium hydrate 9 mol/L, nickel hydroxide 2 mol/L, cobalt hydroxide 2 mol/L, manganese hydroxide 2 mol/L. Tartaric acid is added into the system, such that the concentration of tartaric acid is 4 mol/L. It is aged at 65° C. for 9 hours till it is sticky and transparent. It continues to be aged at the room temperature till the viscosity is 2 Pa·s, so as to obtain the sol precursor.

(2) The sol is put into a syringe whose nozzle aperture is 500 μm. The feeding rate is 7.5 mL/h. The voltage is 30 kV. The fixed distance between the nozzle and the collector is 20 cm. N₂ is blown in till the pressure is 0.4 MPa. The spinning is conducted under the above conditions. Gel fibers are obtained. They are dried at 70° C. for 1 hour.

(3) Gel fibers obtained in step (2) are put into the calcinatory. In the atmosphere, the temperature is raised from the room temperature to 350° C. at a rate of 1° C./min and is held for 2 hours, and then is raised to 700° C. at a rate of 3° C./min and is held for 9 hours. The power-type nickel cobalt lithium manganese oxide material is obtained.

### Embodiment 3

### The Preparation of the Power-Type Nickel Cobalt Lithium Manganese Oxide Material

(1) 100 mL of mixed aqueous solution is prepared, wherein the concentrations are lithium carbonate 18 mol/L, nickel carbonate 3 mol/L, cobalt carbonate 3 mol/L, manganese carbonate 3 mol/L. oxalic acid is added into the system, such that the concentration of organic acid is 5 mol/L. It is aged at 70° C. for 8 hours till it is sticky and transparent. It continues to be aged at the room temperature till the viscosity is 3 Pa·s, so as to obtain the sol precursor.

(2) The sol is put into a syringe whose nozzle aperture is 500 μm. The feeding rate is 10 mL/h. The voltage is 30 kV. The fixed distance between the nozzle and the collector is 30 cm. N₂ is blown in till the pressure is 0.5 MPa. The spinning is conducted under the above conditions. Gel fibers are obtained. They are dried at 70° C. for 1 hour.

(3) Gel fibers obtained in step (2) are put into the calcinatory, in the atmosphere, the temperature is raised from the room temperature to 400° C. at a rate of 1° C./min and is held for 1 hour, and then is raised to 800° C. at a rate of 4° C./min and is held for 10 hours. The power-type nickel cobalt lithium manganese oxide material is obtained.

### Comparing Example

(1) 100 mL of mixed aqueous solution is prepared, wherein the concentrations are lithium acetate 3 mol/L, nickel acetate 1 mol/L, cobalt acetate 1 mol/L, manganese acetate 1 mol/L. The citric acid is added into the system, such that the concentration of organic acid is 3 mol/L. It is aged at 70° C. till it is sticky and transparent. It continues to be aged at the room temperature till the viscosity is 2 Pa·s, so as to obtain the sol precursor.

(2) The sol precursor obtained in step (1) is put into the calcinatory. In the atmosphere, the temperature is raised from the room temperature to 300° C. at a rate of 0.5° C./min and is held for 1 hour, and then is raised to 600° C. at a rate of 2° C./min and is held for 8 hours. The nickel cobalt lithium manganese oxide comparing material is obtained.

Testing Example

With the lithium metal as the negative electrode, with the nickel cobalt lithium manganese oxide material of Embodiment 1 and that of Comparing Example as the positive electrode, a battery is assembled. The discharging test is conducted at a rate of 1 C. “1 C” refers to the discharge ratio is 1 C. “Discharge ratio” refers to the battery discharge current relative to the ratio of nominal capacity. Nominal capacity (mAh)/discharge time(h)=discharge ratio (C). In theory, it use just 1 h to discharge the current of battery with 1 C rate. Results are shown in FIG. 2. As shown in the results, at the rate of 1 C, the specific capacity the nickel cobalt lithium manganese oxide positive electrode material of the present invention, which is around 170 mAh/g, is higher than that of ordinary sol-gel method.

The above embodiments are preferred embodiments of the present invention. However, the implementation of the present invention is not limited to the above embodiments. Any other alternations, modifications, replacements, combinations, simplifications, which do not depart from the spirit and principle of the present invention, are all equivalent alternative methods, which fall within the scope of the present invention.

1. A method for preparing power-type nickel cobalt lithium manganese oxide material, comprising:
adding organic acid into a mixed aqueous solution of a lithium source, a nickel source, cobalt source, and a manganese source;
aging, to obtain a sol precursor;
electrospinning, to obtain a gel fiber; and
calcinating to obtain the power-type nickel cobalt lithium manganese oxide material.

2. The method according to claim 1, wherein in the mixed aqueous solution, a concentration of the nickel source is 1˜3 mol/L, wherein a concentration of the cobalt source is 1˜3 mol/L, wherein a concentration of the manganese source is 1˜3 mol/L, wherein a concentration of the lithium source is 1˜2 times of a total concentration of the nickel source, the cobalt source, and the manganese source.

3. The method according to claim 1, wherein an amount of the organic acid is that a concentration of the organic acid in a system is 3˜5 mol/L after adding the organic acid.

4. The method according to claim 1, wherein the organic acid is at least one of citric acid, tartaric acid, and oxalic acid.

5. The method according to claim 1, wherein the lithium source is at least one of lithium acetate, lithium hydrate, and lithium carbonate; wherein the nickel source is at least one of nickel acetate, nickel hydroxide, and nickel carbonate; wherein the cobalt source is at least one of cobalt acetate, cobalt hydroxide, and cobalt carbonate; and wherein the manganese source is at least one of manganese acetate, manganese hydroxide, and manganese carbonate.

6. The method according to claim 1, wherein the aging includes:
heating to 60˜70° C. first;
aging for 8˜10 hours till transparent; and
continuing aging at a room temperature till a viscosity is 2˜3 Pa·s.

7. The method according to claim 1, wherein process conditions of the electrospinning include: a nozzle aperture being 500 μm, a feeding rate being 5˜10 mL/h, a voltage being 20˜40 kV, a fixed distance between the nozzle and a collector being 10˜30 cm, and a pressure being 0.3˜0.5 MPa.

8. The method according to claim 1, wherein process of the calcination includes:
raising a temperature from the room temperature to 300˜400° C. at a rate of 0.5˜1° C./min and holding for 1˜3 hours;
raising the temperature to 600˜800° C. at a rate of 2˜4° C./min and holding for 8˜10 hours.

9. A power-type nickel cobalt lithium manganese oxide material, wherein the power-type nickel cobalt lithium manganese oxide material is obtained through the preparing method according to claim 1.

10. A use of the power-type nickel cobalt lithium manganese oxide material according to claim 9 in a battery.
